(19) United States
(12) Patent Application Publication
(10) Pub. No.: US 2012/0171568 A1
(43) Pub. Date: Jul. 5, 2012

(54) PRISMATIC BATTERY CELL WELDING

(75) Inventors: Shazad Mahmood Butt, Troy, MI (US); John Kim, Gyeonggi-do (KR)

(73) Assignee: A123 SYSTEMS, INC., Waltham, MA (US)

(21) Appl. No.: 13/344,528

(22) Filed: Jan. 5, 2012

Related U.S. Application Data
(60) Provisional application No. 61/429,942, filed on Jan. 5, 2011.

(51) Int. Cl. H01M 2/30; H01M 10/04

(52) U.S. Cl. 429/211; 29/623.4

(57) ABSTRACT

A prismatic battery cell is provided. The prismatic battery cell includes a plurality of electrode films conducting electricity in the prismatic battery cell, a terminal welded to the plurality of electrodes, and a buffer film welded to the plurality of electrodes, the plurality of electrodes interposing the terminal and the buffer film.

### CROSS-REFERENCE TO RELATED APPLICATIONS

This application claims priority to U.S. Provisional Patent Application No. 61/429,942, filed Jan. 5, 2011 and entitled “ENERGY DISTRIBUTION FOR WELDING ULTRATHIN ELECTRODES USING SACRIFICIAL BUFFER MATERIAL,” the entire contents of which are hereby incorporated herein by reference for all purposes.

### TECHNICAL FIELD

The present description relates to welding a prismatic battery cell.

### BACKGROUND AND SUMMARY

Batteries may be used to store and supply electricity in various applications. Examples of batteries include lead acid, nickel cadmium (NiCd), nickel metal hydride (NiMH), lithium ion (Li-ion), and lithium ion polymer (Li-ion polymer), among others.

Ultrasonic welding may be used to weld electrodes in the battery to one another as well as to terminals in the battery. In particular, a nest and a sonotrode in an ultrasonic welder may be used to apply a pressure and an ultrasonic vibration to the welding materials (i.e., the electrode films and the terminal). However, the ultrasonic welding process may involve tradeoffs between weld strength and damage to the welding material. For example, certain battery cells may require an increased amount of energy to propagate the weld through a large number of electrode films and to the terminal. However, when the energy delivered to the welding material is increase the likelihood of wrinkling, tearing, and stress fracturing of the electrodes is increased. Furthermore, the pattern on the external surfaces of the nest and/or sonotrode in the ultrasonic welder may also cause damage to the electrode film when the pressure is applied to the electrode film.

In one example approach, a prismatic battery cell is provided. The prismatic battery cell includes a plurality of electrode films conducting electricity in the prismatic battery cell, a terminal welded to the plurality of electrodes, and a buffer film welded to the plurality of electrodes, the plurality of electrodes interposing the terminal and the buffer film.

The buffer film protects the electrode films during welding and reduces the stress concentration by dispersing the load over a greater area, thus enabling an increased amount of energy to be delivered to the terminal and the electrode films during welding. In this way, the likelihood of electrode damage is decreased while increasing the weld strength between the electrodes as well as between the electrodes and the terminal. As a result, battery cell operation is improved and the longevity of the battery cell is increased.

In another example approach, a method for welding a prismatic battery cell is provided. The method includes applying pressure to a welding assemblage including a plurality of electrode films, a buffer film, and a terminal via a nest and a sonotrode positioned on opposing sides of the welding assemblage, the plurality of electrode films stacked over one another and interposing the buffer film and the terminal. The method further includes applying ultrasonic vibrations to the welding assemblage via the sonotrode to bond the terminal to the plurality of electrode films.

Again a buffer film may be used to protect the electrode films during welding. As a result, the likelihood of damage to the electrode films during welding is decreased while at the same time enabling an increased amount of energy to be delivered to the welding assemblage, thereby increasing the strength of the weld.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an illustration of a prismatic battery cell.

FIGS. 2 and 3 show cross-sectional views of the prismatic battery cell shown in FIG. 1.

FIGS. 4 and 5 show an ultrasonic welding device for welding a prismatic battery cell.

FIGS. 6 and 7 show methods for welding a prismatic battery cell.

FIGS. 8 and 9 show bar graphs depicting the tensile strength of electrodes in different prismatic battery cells.

### DETAILED DESCRIPTION

A prismatic battery cell having a buffer film welded to an electrode stack with a terminal welded thereto is described herein. The buffer film reduces the point loads applied to the electrode stack and a terminal via the ultrasonic welder during welding. Moreover, the buffer film absorbs and distributes ultrasonic energy to reduce the likelihood of damage to the electrode stack while at the same time enabling an increased energy input to be delivered to the electrode film and the terminal when compared to an ultrasonic welding process which does not utilize a buffer film. As a result, battery cell operation is improved while at the same time increasing the longevity of the battery cell.

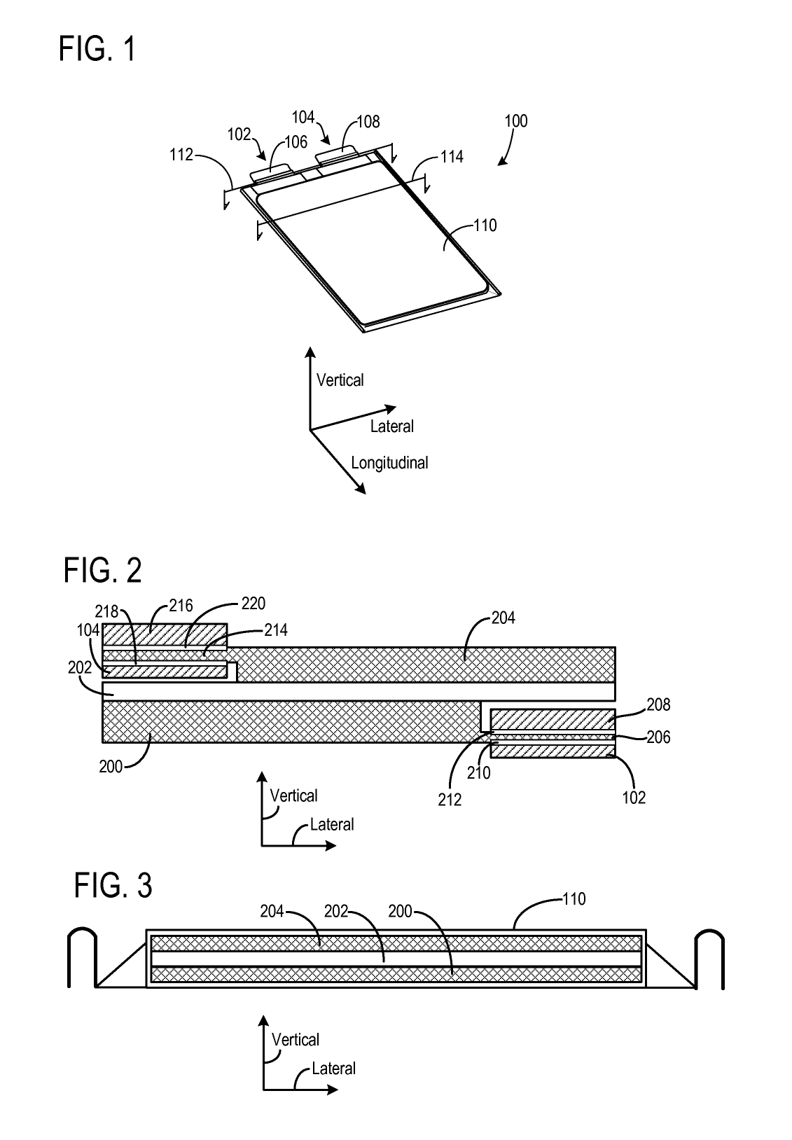

Turning now to FIG. 1 which schematically depicts a prismatic battery cell 100 having a first terminal 102 and a second terminal 104. The terminals are depicted as tabs in FIG. 1. However, in other examples alternate suitable terminals may be utilized. The first terminal 102 may be coupled to an anode in the prismatic battery cell 100 and the second terminal 104 may be coupled to a cathode in the battery cell or vice-versa. As shown, the first terminal 102 has a planar external surface 106 Likewise, the second terminal 104 has a planar external surface 108. The planar external surfaces (106 and 108) are perpendicular to the vertical axis. However, other orientations are possible in other examples. The lateral, longitudinal, and vertical axes are provided for reference. However, it will be appreciated that the battery cell may be arranged in numerous orientations. Additionally, the first and second terminals (102 and 104) are depicted as having a similar size and geometric characteristics. However, in other examples, the size and/or geometric characteristics of the first and second terminals (102 and 104) may differ.

The first and second terminals (102 and 104) may be connected to external apparatuses configured to receive power, such as a bus bar. In this way, a plurality of prismatic battery cells may be electrically coupled. As a result, a battery assembly utilizing a plurality of prismatic battery cells may be scaled for a variety of applications.

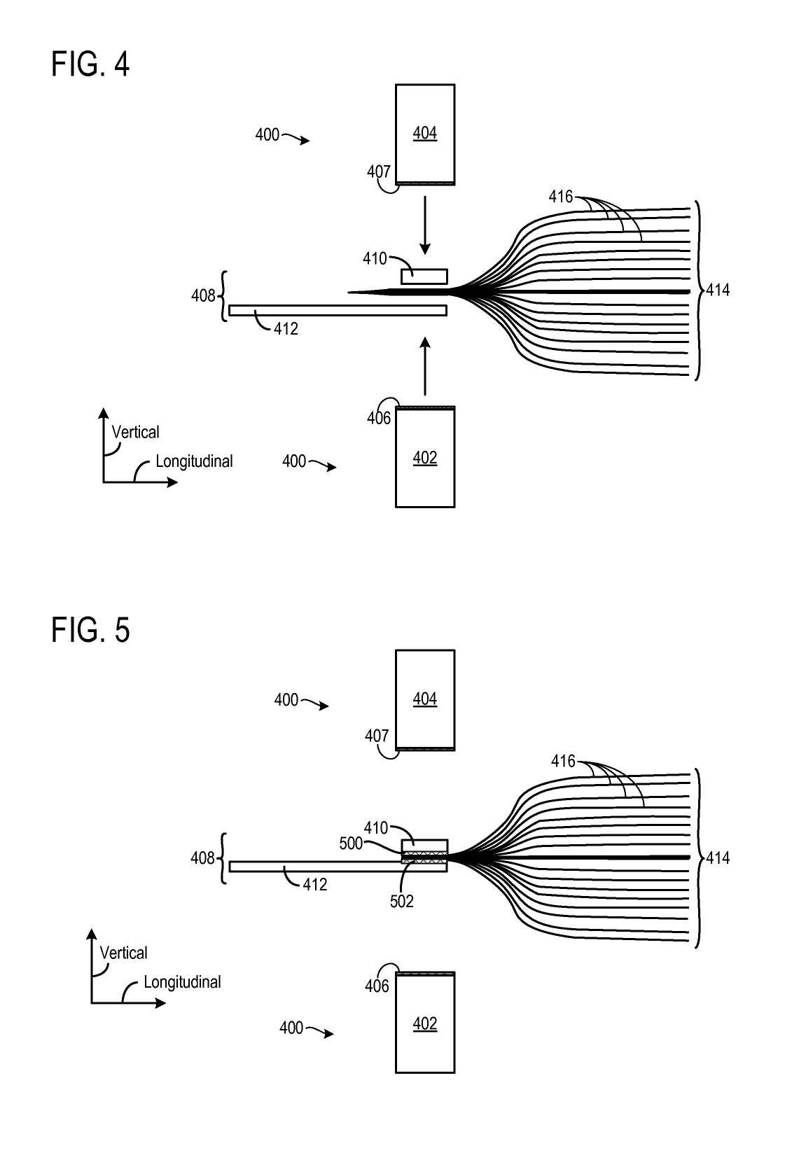

The first and second terminals (102 and 104) may be constructed out of suitable materials, such as aluminum or copper. Specifically in one example, the first terminal 102 may be constructed out of copper and the second terminal 104 may be constructed out of aluminum or vice-versa. Additionally, the first terminal 102 may be coupled to an anode 200, shown in FIG. 2, in the prismatic battery cell 100 and the second terminal 104 may be coupled to a cathode 204, shown in FIG. 2, in the prismatic battery cell 100. The anode 200 and the cathode 204 are discussed in greater detail herein with regard to FIG. 2.

The prismatic battery cell 100 further includes a housing 110 enclosing internal components such as the anode 200 including a plurality of electrode films, an electrolyte 202 shown in FIG. 2, and the cathode 204 including a plurality of electrode films. It will be appreciated that the prismatic battery cell 100 may be a secondary battery cell. That is to say that is may be discharged and recharged a plurality of times.

The lateral axis corresponds to the width of the prismatic battery cell 100 and its constituents. The longitudinal axis corresponds to a length of the prismatic battery cell 100 and its constituents. The vertical axis corresponds to a thickness of the prismatic battery cell 100 and its constituents. Cutting plane 112 defines the cross-section shown in FIG. 2. Cutting plane 114 defines the cross-section shown in FIG. 3.

FIG. 2 shows a cross-section of an example anode 200, electrolyte 202, and a cathode 204 in the prismatic battery cell 100 shown in FIG. 1. The anode 200 includes an electrode film stack having a plurality of electrode films stacked one another, each of which may include a gel-based constituent. The film may be flexible in one example. Likewise, the cathode 204 includes an electrode film stack having a plurality of electrode films stacked on one another. Furthermore, it will be appreciated that the anode 200, electrolyte 202, and cathode 204 may be arranged in alternate configurations. For example, the layers may be rolled or folded on one another. In this way, the compactness of the prismatic battery cell 100 is increased.

A portion 206 of the anode 200 interposes the first terminal 102 and a first buffer film 208. The first terminal 102 is welded to electrode films in the anode 200 via a weld 210. Additionally, the first buffer film 208 is welded to electrode films in the anode 200 via a weld 212. It will be appreciated that the first buffer film 208 is not an electrode film rather it is only coupled to the anode 200 via the weld 212.

The weld 210 continuously extends across the width of the first terminal 102, in the depicted embodiment. As previously discussed with regard to FIG. 1, the width corresponds to the lateral axis. Additionally, the weld 212 continuously extends across the width of the first buffer film 208 in the depicted embodiment. However, other weld configurations for welds 210 and 212 are possible in other embodiments. For example, weld 210 may only partially extend across the width of the first terminal 102. It will be appreciated that the electrode films interposing the first buffer film 208 and the first terminal 102 may be welded to one another, in some examples.

The first buffer film 208 has a greater vertical thickness than the first terminal 102, in the depicted embodiment. When the first buffer film 208 has a greater vertical thickness than the first terminal 102 the damage to the electrode films in the anode 200 may be reduced during welding. However, in other embodiments, the vertical thickness of the first buffer film 208 may be equal to or smaller than the vertical thickness of the first terminal 102. The first buffer film 208 and the first terminal 102 may include the same material. For example, the first buffer film 208 and the first terminal 102 may each include copper. Specifically in one example, the first buffer film 208 and the first terminal 102 may each be substantially constructed out of copper.

Furthermore, a portion 214 of the cathode 204 interposes the second terminal 104 and a second buffer film 216. The second terminal 104 is welded to electrode films in the cathode 204 via a weld 218. Additionally, the second buffer film 216 is welded to electrode films in the cathode 204 via a weld 220. It will be appreciated that the second buffer film 216 is not an electrode film rather it is only coupled to the cathode 204 via the weld 220.

The weld 218 continuously extends across the width of the second terminal 104, in the depicted embodiment. Additionally, the weld 220 continuously extends across the width of the second buffer film 216, in the depicted embodiment. However, other weld configurations for welds 218 and 220 are possible in other embodiments.

Additionally, the second buffer film 216 has a greater vertical thickness than the second terminal 104, in the depicted embodiment. However, in other embodiments, the vertical thickness of the second buffer film 216 may be equal to or smaller than the vertical thickness of the second terminal 104.

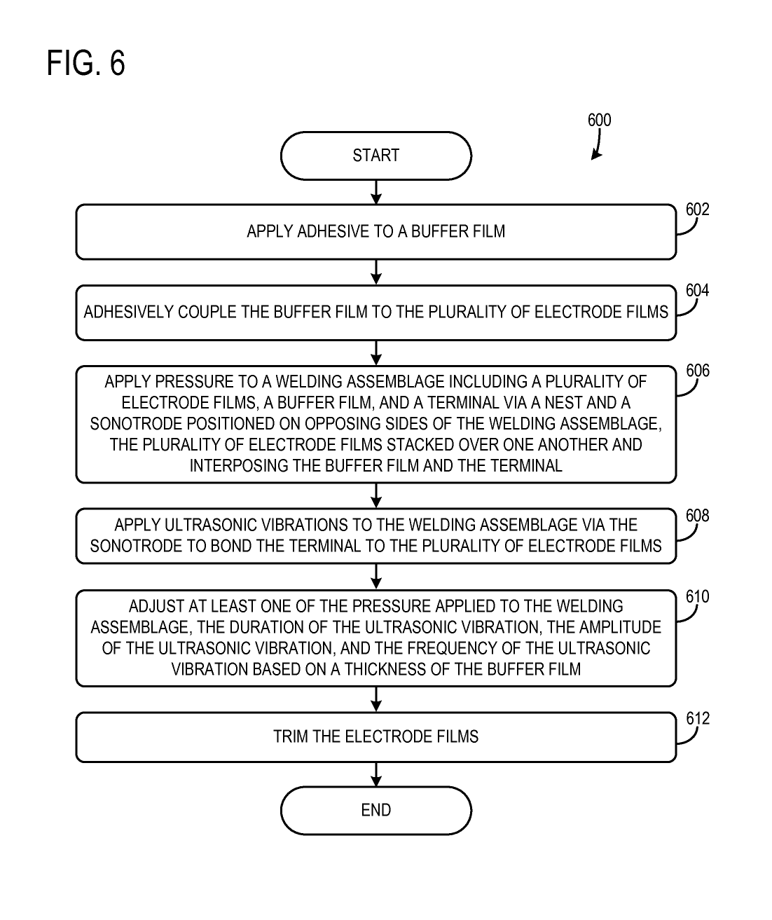

The second buffer film 216 and the second terminal 104 may include the same material. Furthermore, the material in the second buffer film 216 and the second terminal 104 may be different that the material in the first buffer film 208 and the first terminal 102. For example, second buffer film 216 and the second terminal 104 may each include aluminum and specifically may each be substantially constructed out of aluminum and the first buffer film 208 and the first terminal 102104 may each include copper and specifically may each be substantially constructed out of copper. The welds (210, 212, 218, and 220) may each be generated via an ultrasonic welding process discussed in greater detail herein with regard to FIGS. 4-7.

FIG. 3 shows another cross-sectional view of the prismatic battery cell 100, shown in FIG. 1. The anode 200, electrolyte 202, and cathode 204 are depicted. Additionally, the housing 110 enclosing the anode 200, electrolyte 202, and cathode 204 is also depicted. It will be appreciated that the anode 200, electrolyte 202, and cathode 204 may work in conjunction to convert stored chemical energy into electrical energy during discharge of the prismatic battery cell 100. In some examples, the electrode films in the anode 200 and the cathode 204 may be constructed out of different materials. However, in other examples the electrode films in the anode 200 and the cathode 204 may be constructed out of similar materials.

FIG. 4 shows a depiction of an ultrasonic welding device 400 including a nest 402 and a sonotrode 404 for welding a prismatic battery cell, such as the cell 100 shown in FIG. 1. The nest 402 includes an external welding surface 406. Likewise, the sonotrode 404 includes an external welding surface 407. Additionally, the welding surface 406 and/or welding surface 407 may have a pattern, such as a knurl pattern. Therefore, the welding surface 406 and/or welding surface 407 may not be planar and have vertical extensions and depressions. The pattern may reduce slipping of a welding assemblage 408 during the welding.

The nest 402 and the sonotrode 404 are positioned on opposing sides of the welding assemblage 408. The welding assemblage 408 includes a buffer film 410, a terminal 412, and an electrode stack 414 having a plurality of electrode films 416 stacked on one another. The terminal may be the first terminal 102 or the second terminal 104 shown in FIGS. 1 and 2. Additionally, the buffer film 410 may be the first buffer film 208 or the second buffer film 216, shown in FIG. 2. Furthermore, the electrode stack 414 may be included in the anode 200 or the cathode 204, shown in FIG. 2. As previously discussed, the terminal 412 and the buffer film 410 may be constructed out of a similar material, such as aluminum or copper.

The nest 402 is configured to grip and secure the position of the welding assemblage 408. The sonotrode 404 is configured to grip and move the welding assemblage 408. Specifically, the sonotrode 404 may be configured to vibrate within an ultrasonic frequency range or at a specified ultrasonic frequency. In this way, energy in the form of ultrasonic vibrations may be transferred to the welding assemblage 408 to weld elements in the assemblage. Suitable components may be coupled to the sonotrode 404 to enable the aforementioned functionality, such as a transducer.

During welding, the nest 402 and/or the sonotrode 404 may be moved towards one another to apply a pressure to the welding assemblage 408. The pressure applied to the welding assemblage 408 may be selected based on the thickness of the buffer film 410, terminal 412, and/or electrode stack 414. The pressure applied to the welding assemblage 408 may also be selected based on the materials in the buffer film 410, terminal 412, and/or electrode stack 414. The pressure applied to the welding assemblage 408 removes oxide layers and exposes reactive layers that will form an ultrasonic metal bond.

After and/or during the application of pressure to the welding assemblage 408 ultrasonic vibration may also be delivered to the welding assemblage 408 via the sonotrode 404. In this way, energy may be transferred to the welding assemblage 408 to bond various layers in the assemblage. The energy transferred to the welding assemblage 408 via ultrasonic vibration may be selected based on the thickness of the buffer film 410, terminal 412, and/or electrode stack 414. The energy transferred to the welding assemblage 408 via ultrasonic vibration may also be selected based on the materials in the buffer film 410, terminal 412, and/or electrode stack 414. An ultrasonic vibration may be defined as an acoustic vibration having a frequency that is equal to or greater than 20,000 hertz. However, in other examples the cut-off frequency may not be 20,000 hertz. The buffer material enables increase pressure and energy to be delivered to the welding assemblage 408 during welding without increasing the likelihood of damage (e.g., wrinkling, tearing, stress fracturing, etc.) to the terminal 412 and the electrode stack 414.

FIG. 5 shows the welding assemblage 408 depicted in FIG. 4 after ultrasonic welding has been implemented via the ultrasonic welding device 400. As shown, a first weld 500 is formed between the buffer film 410 and the electrode stack 414. As shown the first weld 500 continuously extends down the length of the buffer film 410. However, other weld configurations are possible in other examples. Furthermore, a second weld 502 is also formed between the terminal 412 and the electrode stack 414. In some examples, electrodes in the electrode stack 414 may also be welded to one another. Furthermore, the electrode films 416 in the electrode stack 414 are also trimmed such that they do not longitudinally extend beyond the buffer film 410. However, in other examples, the electrode stack 414 may be trimmed in a different manner or may not be trimmed.

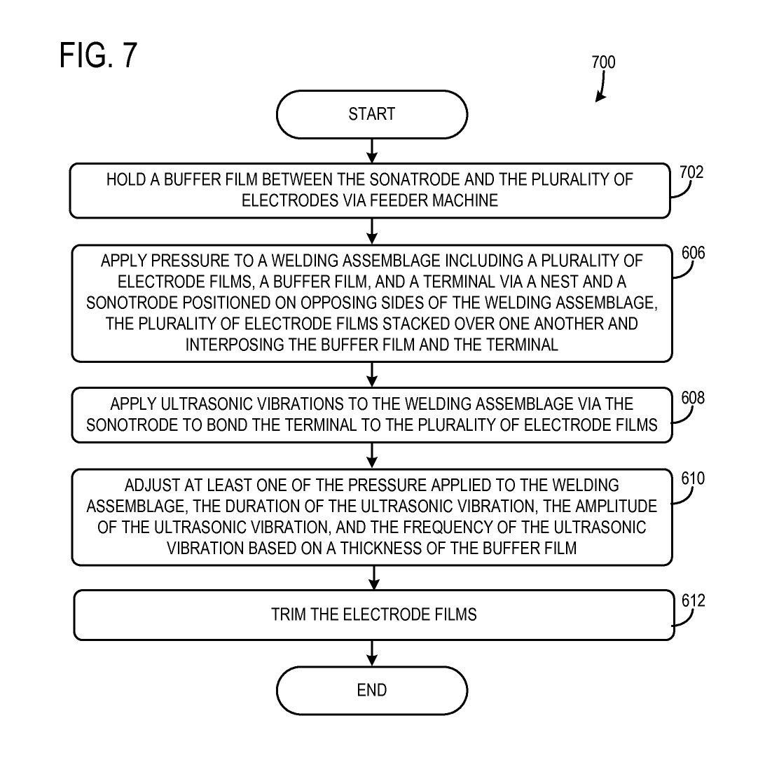

FIG. 6 shows a method 600 for welding a prismatic battery cell. Method 600 may be implemented via the system and components described above with regard to FIGS. 1-5 or may be implemented by other suitable systems and components.

At 602 the method includes applying adhesive to a buffer film. Next at 604 the method includes adhesively coupling the buffer film to the plurality of electrode films.

At 606 the method includes applying pressure to a welding assemblage including a plurality of electrode films, a buffer film, and a terminal via a nest and a sonotrode positioned on opposing sides of the welding assemblage, the plurality of electrode films stacked over one another and interposing the buffer film and the terminal. In some examples, the nest may be in face sharing contact with the terminal. Further in some examples, the sonotrode may be in face sharing contact with the buffer film.

Next at 608 the method includes applying ultrasonic vibrations to the welding assemblage via the sonotrode to bond the terminal to the plurality of electrode films.

At 610 the method includes adjusting at least one of the pressure applied to the welding assemblage, the duration of the ultrasonic vibration, the amplitude of the ultrasonic vibration, and the frequency of the ultrasonic vibration based on a thickness of the buffer film.

Next at 612 the method includes trimming the electrode films. In some examples, the electrode films may be trimmed such that they do not longitudinally extend beyond the buffer film. However, in other examples other trimming techniques may be utilized.

FIG. 7 shows another method 700 for welding a prismatic battery cell. Method 700 include some steps that are similar to the steps in method 600, therefore similar steps are labeled accordingly. Additionally, the description of the similar steps has been omitted for concision. Method 700 may be implemented via the system and components described above with regard to FIGS. 1-5 or may be implemented by other suitable systems and components. At 702 the method includes holding a buffer film between the sonatrode and the plurality of electrodes via feeder machine. After 702 the method proceeds to 606.

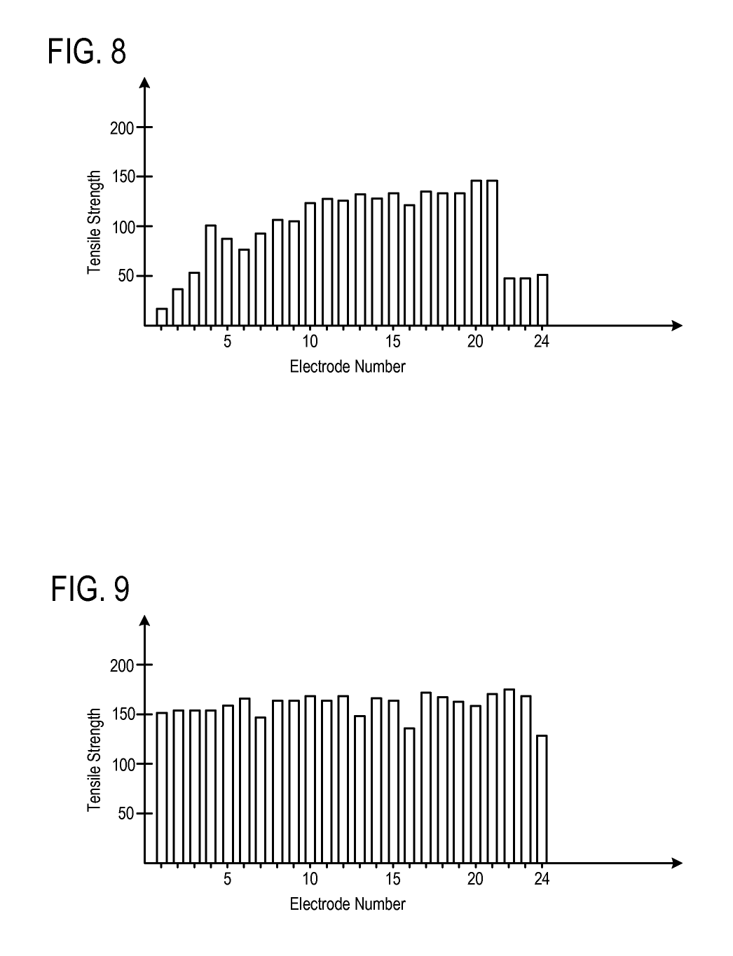

FIGS. 8 and 9 show bar graphs depicting the tensile strength of electrode films in two different battery cells. Specifically, FIG. 8 shows the tensile strength of electrode films in a prismatic battery cell having a terminal ultrasonically welded to the electrode films without the use of a buffer film and FIG. 9 shows a bar graph depicting the tensile strength of electrode films in a prismatic battery cell having a terminal ultrasonically welded to the electrode films with the use of a buffer film as discussed above with regard to FIGS. 1-7. As shown, the tensile strength of all of the electrode films is increased when a buffer film is utilized in the welding process and specifically the strength of the peripheral electrodes (i.e., electrodes 1-3 and 22-24) is dramatically increased. Thus, when a buffer film is utilized in an ultrasonic welding process coupling a terminal to electrode films the strength of the weld can be increased without damaging the electrode films.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A prismatic battery cell comprising:
a plurality of electrode films conducting electricity in the prismatic battery cell;
a terminal welded to the plurality of electrodes; and
a buffer film welded to the plurality of electrode films, the plurality of electrodes interposing the terminal and the buffer film.

2. The prismatic battery cell of claim 1, wherein the plurality of electrode films are included in an anode of the prismatic battery cell.

3. The prismatic battery cell of claim 2, wherein the terminal and the buffer film comprise the same material.

4. The prismatic battery cell of claim 3, wherein the material is copper.

5. The prismatic battery cell of claim 4, further comprising a plurality of electrode films included in a cathode in the prismatic battery cell, a second terminal welded to the plurality of electrode films in the cathode, and a second buffer film welded to the plurality of electrodes.

6. The prismatic battery cell of claim 5, wherein the second terminal and the second buffer film include the same material.

7. The prismatic battery cell of claim 6, wherein the second terminal and the second buffer film comprise aluminum.

8. The prismatic battery cell of claim 1, wherein the weld between the terminal and the plurality of electrode films continuously extends across a width of the terminal.

9. The prismatic battery cell of claim 1, wherein the weld between the buffer film and the terminal continuously extends across a width of the buffer film.

10. The prismatic battery cell of claim 1, wherein the terminal is a tab having a substantially planar external surface.

11. The prismatic battery cell of claim 10, wherein the buffer film has a greater thickness with regard to an axis perpendicular to the planar external surface than the terminal.

12. A method for welding a prismatic battery cell comprising:
applying pressure to a welding assemblage including a plurality of electrode films, a buffer film, and a terminal via a nest and a sonotrode positioned on opposing sides of the welding assemblage, the plurality of electrode films stacked over one another and interposing the buffer film and the terminal; and
applying ultrasonic vibrations to the welding assemblage via the sonotrode to bond the terminal to the plurality of electrode films.

13. The method of claim 12, further comprising, prior to applying pressure, applying adhesive to a buffer film.

14. The method of claim 13, further comprising subsequent to the step of applying adhesive, adhesively coupling the buffer film to the plurality of electrode films.

15. The method of claim 12, further comprising, prior to the step of applying pressure, holding the buffer film between the sonatrode and the plurality of electrodes via feeder machine.

16. The method of claim 12, wherein the nest is in face sharing contact with the terminal.

17. The method of claim 12, wherein the sonotrode is in face sharing contact with the buffer film.

18. The method of claim 12, further comprising adjusting at least one of the pressure applied to the welding assemblage, the duration of the ultrasonic vibration, the amplitude of the ultrasonic vibration, and the frequency of the ultrasonic vibration based on a thickness of the buffer film.

19. A prismatic battery cell comprising:
an anode including a plurality of electrode films of an electrode stack;
a first planar terminal welded to the plurality of electrode films in the anode;
a first buffer film welded to the plurality of electrode films included in the anode, the plurality of electrode films in the anode interposing the first terminal and the first buffer film;
a cathode including a plurality of electrode films of an electrode stack;
a second terminal welded to the plurality of electrode films in the cathode; and
a second buffer film welded to the plurality of electrode films included in the cathode, the plurality of electrode films in the cathode interposing the second terminal and the second buffer film.

20. The prismatic battery cell of claim 19, wherein the first terminal and the first buffer film include a first material and the second terminal and the second buffer film includes a second material different from the first material.

21. The prismatic battery cell of claim 20, wherein the first material is copper and the second material is aluminum.
